(19) United States
(12) Patent Application Publication
(10) Pub. No.: US 2025/0143367 A1
(43) Pub. Date: May 8, 2025

(54) MULTIPURPOSE UTILITY SMOKING DEVICE

(71) Applicants: Sean Lambert, Las Vegas, NV (US); Vincent Lambert, Las Vegas, NV (US); Michael Lambert, Las Vegas, NV (US); Patricia Lambert, Las Vegas, NV (US)

(72) Inventors: Sean Lambert, Las Vegas, NV (US); Vincent Lambert, Las Vegas, NV (US); Michael Lambert, Las Vegas, NV (US); Patricia Lambert, Las Vegas, NV (US)

(21) Appl. No.: 18/934,486

(22) Filed: Nov. 1, 2024

Related U.S. Application Data
(60) Provisional application No. 63/547,308, filed on Nov. 3, 2023.

(51) Int. Cl. A24F 3/00; A24F 5/10; A24F 7/00; A47J 42/14

(52) U.S. Cl. CPC A24F 3/00; A24F 5/10; A24F 7/00; A47J 42/14

(57) ABSTRACT

A multipurpose utility smoking device includes a housing with a grinder, a chamber for storing and loading, and a mouthpiece for smoking. The device features a bowl aligned with a bowl hole, a cam stem, and a mouthpiece stem, all of which are housed or partially housed within the chamber. The cam stem and mouthpiece stem are coupled to a lever and a bracket respectively, allowing for sliding movement relative to the housing. The device also includes a first gasket and spring coupled to the cam stem, and a tube providing fluid communication between the mouthpiece stem and the adapter. The device's panels are coupled to the housing by at least one fastener. The lever and bracket allow for the bowl to be moved between a smoking and nonsmoking position.

### CROSS REFERENCE TO RELATED APPLICATION

The present application claims the benefit under 35 U.S.C. 119 of U.S. Provisional Patent Application Ser. No. 63/547,308 filed Nov. 3, 2023. The U.S. Provisional Patent Application Ser. No. 63/547,308 is hereby incorporated by reference in its entirety.

### FIELD OF THE INVENTION

The present specification relates generally to a system for smoking and more

specifically a system that can grind, store, load and then allow the user to smoke various herbs and tobaccos.

### BACKGROUND OF THE INVENTION

Tobacco pipes and grinders have been integral to the enjoyment of tobacco and herbal blends for generations. Herb and tobacco pipes are utilized to inhale the aromatic and flavorful smoke produced by combusting herbs and tobacco. Grinders aid in breaking down herb and tobacco leaves or blends into finer particles, optimizing the combustion or vaporization process. Over time, a variety of designs and modifications have been developed to cater to user preferences and technological advancements. In addition, maintaining the aroma, flavor, and efficacy of these products is essential for a satisfying experience. However, improper storage can lead to deterioration, affecting the overall enjoyment and effectiveness of tobacco and cannabis.

A conventional pipe usually consists of a mouthpiece, a through hole, and a bowl that has a chamber for holding the herbs or tobaccos. These elements have evolved to provide improved airflow, cooling mechanisms, and aesthetics. Similarly, grinders have seen developments in terms of materials, tooth patterns, and portability, all aimed at achieving a finer grind and ease of use. These grinders usually have a grinding chamber that have teeth or pegs that grind the herbs and tobaccos into the fine material. Grinders typically have two halves, a top and a bottom half which can be separated to allow the user to put the herbs or tobaccos into the inside chamber. Each side can have teeth which are close together so when the user rotates the top and bottom the teeth grind the material down to a useable size. Grinding the material breaks down the material into finer particles and allows for a more even burn, leading to a smoother smoke experience.

Once the material is ground down the user will either typically smoke the material right away or store the material for future use which requires the user to either store it in the grinder or empty the material in a container. Traditional storage methods often involve using airtight containers to mitigate exposure to external elements. While effective to some extent, these containers may still fall short in preserving the ideal conditions for extended periods. Factors such as humidity control, light protection, and compartmentalization have not been fully optimized in existing storage solutions. These containers can store the herbs or tobaccos away from the elements such as high temperatures, exposure to ultraviolet light, air and high humidity. The storage container is usually glass storage, humidors, plastic containers, or vials which can keep the herbs and tobacco safe until usage.

Once the user is ready to smoke the herb or tobacco the user typically removes the material from the grinder or storage container and puts it into ta cigarette roll, hookah, or bowl of a bong where the fine material is packed and then lite for smoking. A typical bowl is often empty chambers that allow for the loose material to be packed into it for the user to light for smoking. Bowls are usually made from glass, metals, silicone, wood, or ceramics. The bowls vary in size allowing the user to choose how much material is placed in the bowl and smoked by the user. Current systems usual have at least one component of the grinder, storage container, loader and bowl but one of the major disadvantages of these systems is that it requires the user to have completely separate pieces to carry with them if the user wants to smoke.

Despite these advancements, there remains room for innovation to each component as whole. Existing herb and tobacco pipes, grinders, storage container may have limitations in terms of usability, durability, and features. As the demand for convenient and efficient herb and tobacco consumption accessories continues to grow, there is a need for improved designs that offer enhanced user satisfaction, ease of maintenance, and aesthetic appeal.

Therefore, there is a need in the marketplace for a system that combines all four devices into one complete system allowing the user to grind, store, load and then smoke the material.

### BRIEF SUMMARY OF THE INVENTION

Accordingly, the present invention is a multipurpose utility smoking device for grinding, storing, loading, and then smoking can comprise a housing wherein the housing can have a grinder coupled to it. The device can comprise a housing with a top, bottom, front, back, and two panels that define a chamber. The top of the housing features a bowl hole, the front includes a mouthpiece opening, and the bottom has a cam stem hole. The device can include a grinder coupled to the second panel and a bowl housed within the chamber, aligned with the bowl hole, and coupled to an adapter. A cam stem is slidably coupled to the adapter and further coupled to a lever.

The device can also include a mouthpiece mounted to a mouthpiece stem, which is in fluid communication with the adapter and housed within the chamber. The mouthpiece can be slidably coupled to the mouthpiece opening, and the mouthpiece stem is coupled to a bracket that is configured to slide relative to the housing. The cam stem of the device has a first gasket coupled to the bottom, and a first spring coupled between the first gasket and the adapter. The mouthpiece stem is in fluid communication with the adapter by a tube having a first end and a second end.

The first end can be coupled to the mouthpiece stem and the second end can be coupled to the adapter. The mouthpiece has a filter coupled to its inner diameter and a mouthpiece stop coupled to its outer diameter. The bracket of the device has an open position and a closed position. When the bracket is in the open position, the bowl is exposed, and when in the closed position, the bowl is hidden under the bracket within the chamber. The lever pulls the cam stem vertically, moving the bowl in a smoking position or a nonsmoking position.

In the smoking position, the bowl can be mated against the bowl hole, and in the nonsmoking position, the bowl is mated against the bracket. The bracket can have a second spring around the mouthpiece stem coupled between the bracket and a second gasket axially aligned with the mouthpiece hole and coupled to the housing. Both the first spring and the second spring are compression springs. The bowl of the device can be made from various materials such as glass, metals, silicone, wood, or ceramic. The first panel and second panel can be coupled to the housing by at least one fastener.

This multipurpose utility smoking device simplifies the smoking process by integrating multiple functions into a single device. The device can be designed to be user-friendly, with features such as a sliding bracket and lever-operated cam stem for easy operation. The use of compression springs and gaskets ensures a tight seal and smooth operation, enhancing the overall smoking experience.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the. Absent such clear statements of intent to apply a “special” definition, it is the inventor's intent and desire that the simple, plain, and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for” and will also recite the word “function” (i.e., will state “means for performing the function of . . . , without also reciting in such phrases any structure, material or act in support of the function. Thus, even when the claims recite a “means for performing the function of molding a . . . , step for performing the function of molding a . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

Additional features and advantages of the present specification will become apparent to those skilled in the art upon consideration of the following detailed description of the illustrative embodiment exemplifying the best mode of carrying out the invention as presently perceived.

### BRIEF DESCRIPTION OF THE DRAWINGS

These and other features, aspects, and advantages of the present specification will become better understood with regard to the following description, appended claims, and accompanying drawings where:

FIG. 1 is an isometric view of the multipurpose utility smoking device in accordance to one, or more embodiments;

FIG. 2 is a bottom view of the multipurpose utility smoking device in accordance to one, or more embodiments;

FIG. 3 is a side view of the multipurpose utility smoking device in accordance to one, or more embodiments;

FIG. 4 is a back view of the multipurpose utility smoking device in accordance to one, or more embodiments;

FIG. 5 is a side view of the multipurpose utility smoking device with a first panel omitted in accordance to one, or more embodiments;

FIG. 6a is a front view of the multipurpose utility smoking device in accordance to one, or more embodiments;

FIG. 6b is a cross sectional view of FIG. 6a of the multipurpose utility smoking device in accordance to one, or more embodiments;

FIG. 7 is a top view of the multipurpose utility smoking device in accordance to one, or more embodiments;

FIG. 8 is a side view of the multipurpose utility smoking device in accordance to one, or more embodiments;

FIG. 9 is an top isometric view of another embodiment of the multipurpose utility smoking device in accordance to one, or more embodiments;

FIG. 10 is a side view of another embodiment of the multipurpose utility smoking device in accordance to one, or more embodiments;

FIG. 11a is a back view of another embodiment of the multipurpose utility smoking device in accordance to one, or more embodiments;

FIG. 11b is a cross-sectional view of FIG. 11a of another embodiment of the multipurpose utility smoking device in accordance to one, or more embodiments;

FIG. 11c is a cross-sectional view of FIG. 11a of yet another embodiment of the multipurpose utility smoking device in accordance to one, or more embodiments;

FIG. 12 is a bottom isometric view of another embodiment of the multipurpose utility smoking device in accordance to one, or more embodiments;

FIG. 13 is a isometric view of yet another embodiment of the multipurpose utility smoking device in accordance to one, or more embodiments;

FIG. 14 is a side view of another embodiment, omitting one of its sides, of the multipurpose utility smoking device in accordance to one, or more embodiments;

FIG. 15a is a front view of another embodiment of the multipurpose utility smoking device in accordance to one, or more embodiments; and

FIG. 15b is a cross-sectional view of FIG. 15a of another embodiment of the multipurpose utility smoking device in accordance to one, or more embodiments; and

Elements and acts in the figures are illustrated for simplicity and have not necessarily been rendered according to any particular sequence or embodiment.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

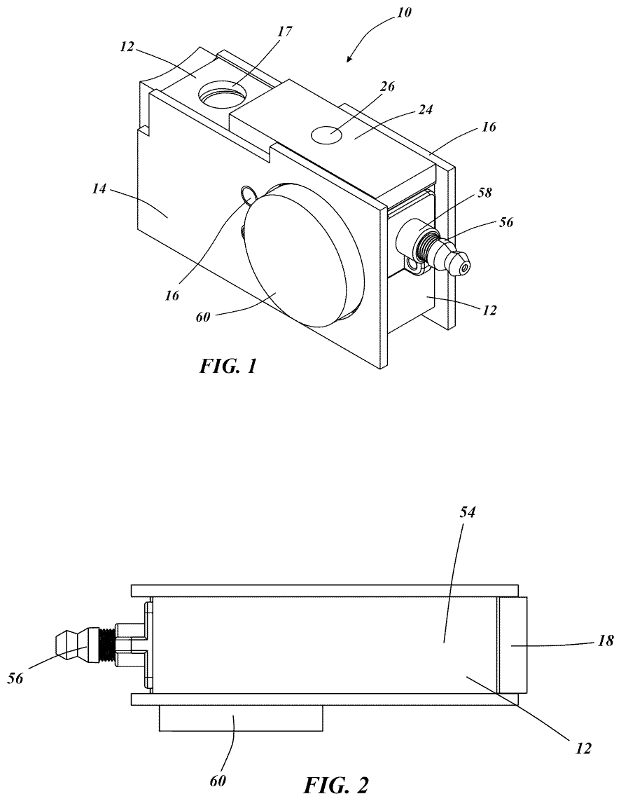

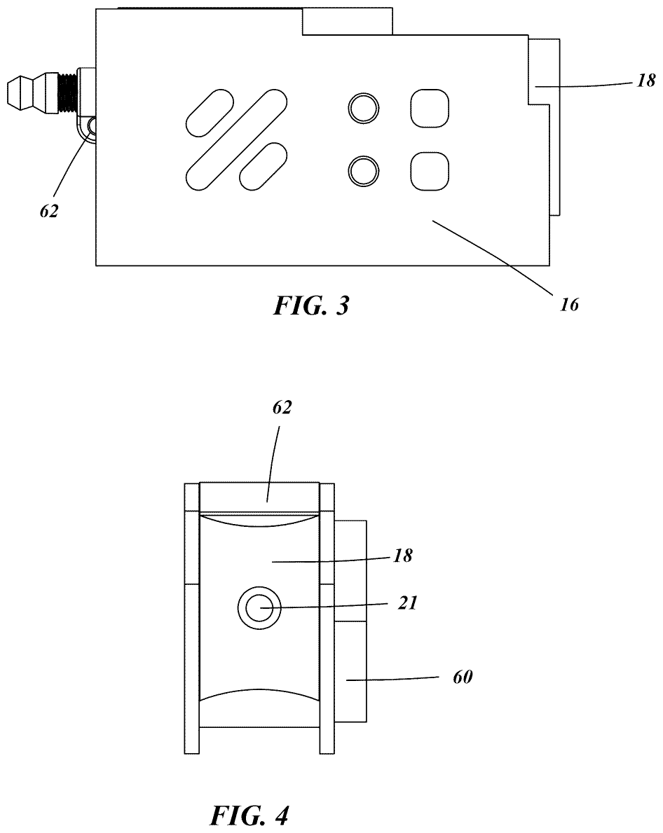

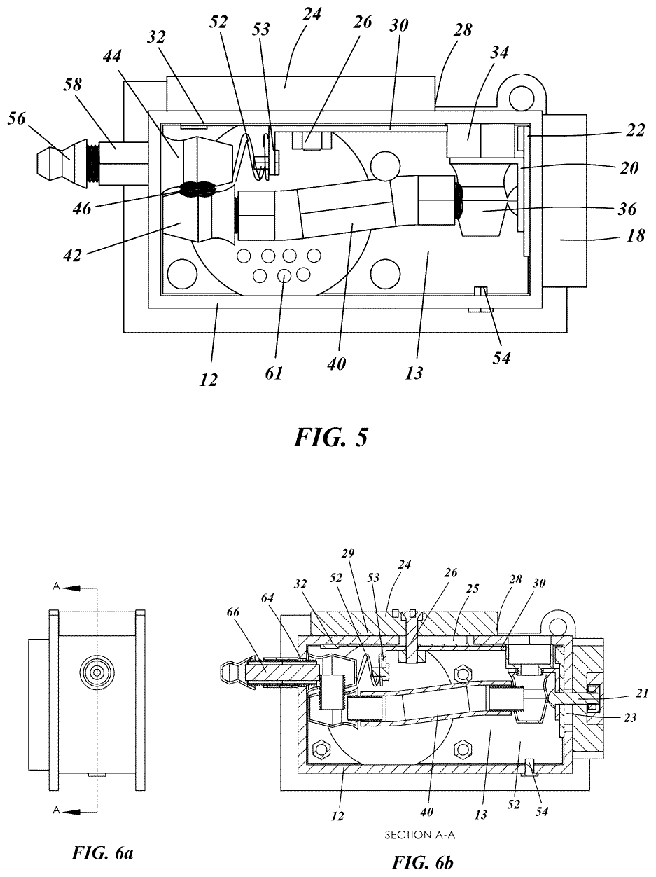

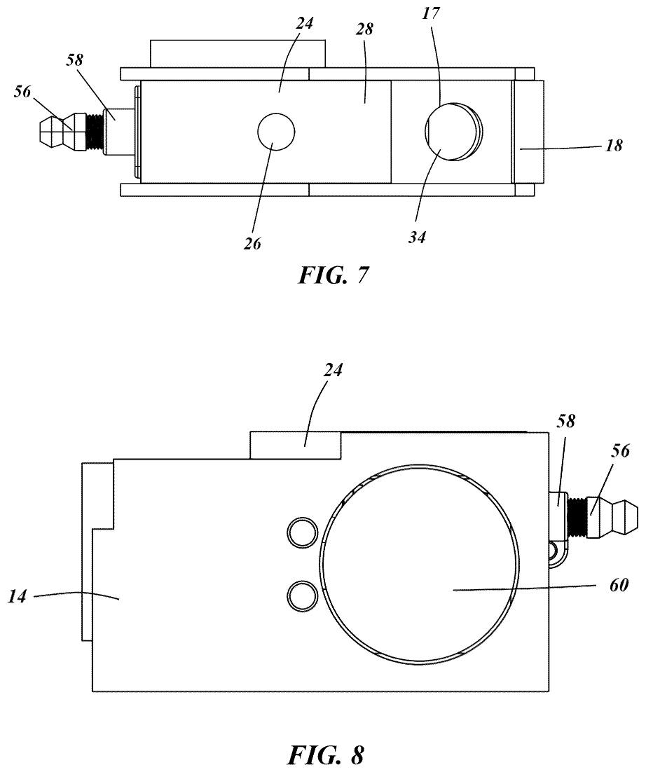

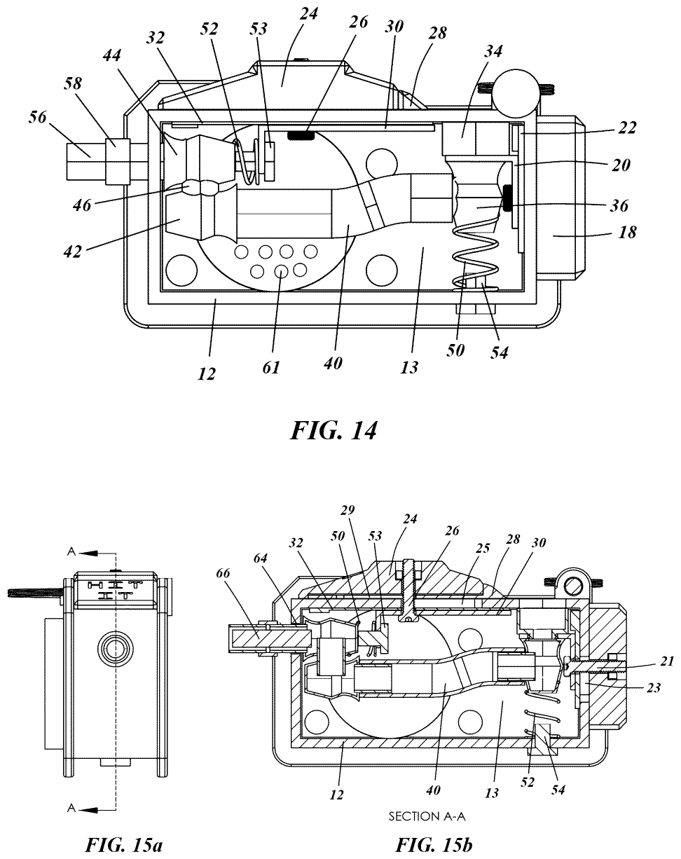

Referring initially to FIGS. 1-8 and FIGS. 13-15b, a multipurpose utility smoking device for grinding, storing, loading, and then smoking is shown generally at 10. The multipurpose utility smoking device 10 can comprise a housing 12 wherein the housing can have a grinder 60 coupled to it. The grinder 60 can be coupled to the housing 12 by such as, for example, press fit, adhesive, fasteners, magnets, or the like. The housing 12 can have a chamber 13 for storing the ground up herb or tobacco. The grinder 60 can allow the user to grind the herb or tobacco directly into the chamber 13. The grinder 60 can two halves that each have teeth or pegs that shred and break down the herb or tobacco when the two halves are rotated. The grinder 60 can have at least one opening 61 on its bottom that allows the fine material to fall into the chamber 13 when the user rotates the grinder or in other embodiments the at least one opening is omitted. The grinder 60 can be manufactured from any durable material such as, for example, aluminum, stainless steel, or zinc alloy or any other similar material that can withstand the repeated grinding process and provide for long-term use.

The housing 12 can be any suitable shape and size but in the preferred embodiment the housing can be rectangular with a chamber 13 to allow for the grinded material. The housing 12 can be made from such as, for example, stainless steel, aluminum, carbon fiber, plastic, wood, glass, ceramic, or the like. The housing 12 can have at least two sides, a top and a bottom wherein the housing can have a bowl hole located on its top. The two side can be open forming a chamber 13 in the housing 12. The housing 12 can have a first panel 14 and a second panel 16 coupled to it covering the two sides. The first panel 14 and the second panel 16 can be coupled to the housing 12 by such as, for example, fasteners, adhesive, rivets, or the like. In certain embodiments, the first panel 14 and second panel 16 can have a gasket compressed between the housing and the first panel and second panel keeping the chamber 13 airtight.

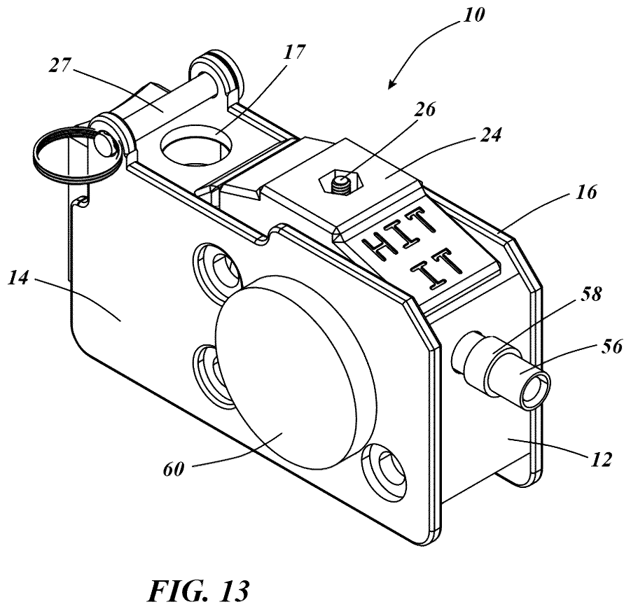

In embodiments, the multipurpose utility smoking device 10 can comprise a first handle 24 and a second handle 18 which can be slidably coupled to the housing 12. The first handle 24 can be on the top of the housing 12 wherein the first handle can be slidably coupled to the housing by a first fastener 26 that is coupled to a bracket 30 wherein a first slide gasket 32 can be place between the housing 12 and the first slide bracket which can allow of the first handle to slide smoothly and keep a seal between the bracket 30, first slot 25 and first handle 24. The first fastener 26 can be inserted in and slide within a first slot 25 wherein the first slide gasket 32 can have a corresponding slot and can be attached to the housing 12 allowing the first slide bracket to slide smoothly within the housing 12. The first slide gasket 32 can be made from such as, for example, delrin, plastic, PEEK, rubber, metals, or the like. The first handle 24 can be any suitable shape and size as shown in FIG. 1 and FIG. 13.

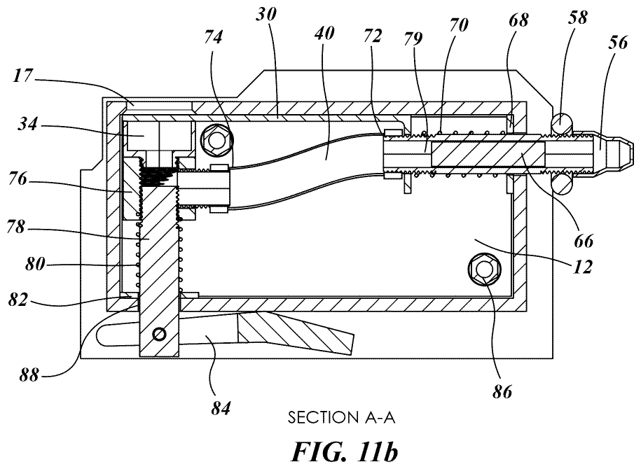

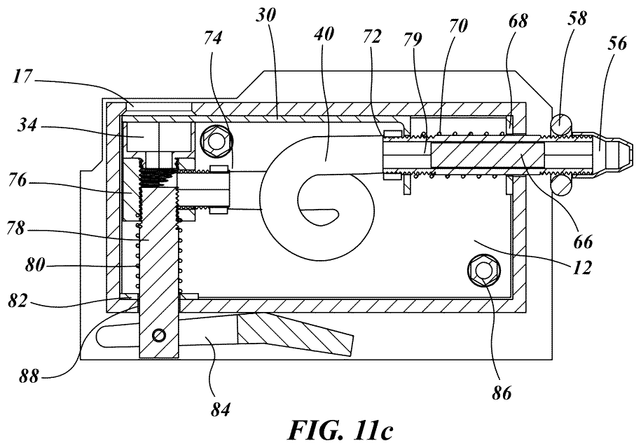

The first handle 24 can have a bowl cover 28 slidably coupled to it. The bowl cover 28 can move back and forth freely within the first handle 24. The bowl cover 28 can slide forward to cover the bowl hole 17. The bowl cover 28 can have a bowel cover slot 29 which can allow the bowl cover to move freely between the housing 12, the first fastener 26, and the first handle 24 as shown in FIG. 15b. The bowl cover 28 can move separately of the first handle 24 or can move with the first handle. The bowl handle 28 can be made from such as, for example, metal, aluminum, stainless steel, plastic, rubber, or the like. The bowl handle 28 can have the same or similar slope as the first handle's 24 forward slope. The bowl handle 28 can be any suitable shape or size but in the preferred embodiment the shape is as shown in FIG. 1. In other embodiments, the bracket 30 can cover the bowl 34 as shown in FIG. 11b.

The bracket 30 can move back and forth within the housing 12 when the first handle 24 moves back and forth by the user. The bracket 30 can be coupled to a first guide 53 wherein the first guide can be coupled to a first spring and in other embodiments the spring can be omitted. The first spring can be coupled to a first fitting 44 which is removably coupled to a mouthpiece 56, or the spring can be omitted. The mouthpiece 56 can extend from the housing 12 from a second housing hole 64 wherein the first fitting can be pushed against the housing by the first spring keeping the first fitting in place. The mouthpiece 56 can have a filter 66 coupled to it and can capture the filter when coupled to the first fitting 44 and when the mouthpiece is removed from the first fitting the filter can be removed and replaced as shown in FIG. 6b. The mouthpiece can have a mouthpiece stop 58 coupled to it wherein the mouthpiece stop can be a bigger diameter or a small diameter as the mouthpiece. In certain embodiments, the first fitting can have a gasket between the housing 12 and the mouthpiece 56 and the mouthpiece stop 58 can be omitted.

In embodiments, a bowl 34 can be placed inside the housing 12 and under a bowl hole 17 wherein the bowl can be coupled to a second handle 18. The bowl 34 can be coupled to a third fitting 36 wherein a second slide bracket 20 can be coupled between the third fitting and the bowl. The second slide bracket 20 can be slidably coupled to a second handle 18 by a second fastener 21 wherein as the second handle can move up and down with the third fitting 36, bowl 34, and second slide bracket 20 within the housing 12 allowing the bowl to be moved away from the bowl hole 17. The second fastener 21 can move within the housing in a second slot 23 wherein the second handle 18 and the second slide bracket 20 can capture and compress a second slide gasket 22 between the second slide bracket and housing keeping a seal between the housing and the second slot 23 as the user moves the second handle 18 up and down. The bracket 30 and the second slide bracket 20 can be such as, for example, L-brackets, channel bracket, strut bracket, or the like. The second slide gasket 22 can be made from such as, for example, delrin, plastic, PEEK, rubber, metals, or the like. The bowl 34 can be made from such as, for example, ceramics, silicone, glass, wood, titanium, or the like. The bowl 34 can be coupled to the third fitting 36 by such as, for example, screwed in, adhesive, bolted or the like.

The third fitting 36 can be coupled to a second spring 52 which can be coupled to a second guide 54 wherein the second guide can be coupled to the housing and can keep the second spring contained and in other embodiments the second spring can be omitted as shown in

FIG. 11c. The second spring 52 can keep a constant force on the third fitting 36 keeping it pressed against the housing 12. The first spring 50 and the second spring 52 can be such as, for example, a compression spring, linear spring, coil spring, helical spring, or the like.

The second handle 18 can allow the user to move the bowl 34 away from the housing and allow the herb or tobacco that is within the housing to be placed, pressed or shaken into the bowl and can allow the user when the herb or tobacco is in the bowl to press the bowl against the housing or first slide bracket keeping the herb or tobacco in within the bowl. The first fastener 26 and the second fastener 21 can be such as, for example, screw, bolt and nut, adhesive, rivet, anchors, nails or the like.

In embodiments the third fitting 36 can be coupled to a tube 40 wherein the tube can extend and be coupled to a second fitting 42. The second fitting 42 can be coupled to the first fitting 44 by a fitting adapter 46. The first fitting 44, second fitting 42, and third fitting 36 can be such as, for example, acorn armback fitting, 90-degree fitting, coupling, elbow, or the like. The adapter 46 can couple the first fitting 44 and the third fitting together and the adapter can be such as, for example, male or female pipe adapter, flare adapter, seal-Lok, push to connect fittings, quick connect fitting, or the like. The tube 40 can have a bend in it to allow the bowl 34 and third fitting 36 to move up and down. The tube 40 can be such as for example, plastic tubing, rubber tubing, metal tube, or the like and can be any suitable shape or size and can be shield with an outer layer such as a spring to prevent kinking or can have a circular bend to allow for movement without kinking the tube as shown in FIG. 11c. The tube 40 can allow the user to pull smoke from the bowl 34 to the mouthpiece 56.

The first fitting 44, adapter 46, second fitting 42, tube 40, first spring 50, second spring 52, third fitting 36, the bracket 30, second slide bracket 20, first slide gasket 32, second slide gasket 22, bowl 34 can be contained within the housing 12 chamber 13. The chamber 13 can additionally house the grinded material and can be sealed to keep the material fresh. The housing 12 can have a first panel 14 and a second panel 16 coupled to its sides wherein the first panel and the second panel can be sealed by such as, for example, a gasket, adhesive, O-ring, or the like. The first panel 14 and the second panel 16 can be made from such as, for example, stainless steel, aluminum, metal, plastic, carbon fiber, ceramic, or the like. The first panel 14 and the second panel 16 can extend past the housing 12 or can be the same size as the housing. The first guide 53 and the second guide 54 can be such as for example, rivet, bolt, pins, dowel pin, or the like. The first panel 14 and the second panel 16 can comprise an attachment point for a pin 62 wherein the pin can be such as, for example, cotter pin, clevis pin, quick release pin, dowel pin, captive pin, or the like.

The method of using the multipurpose utility smoking device 10 comprising grinding down the herb or tobacco with grinder 60 into the chamber 13. The grounder material can be stored in the chamber until ready to use. When ready to use the user can uncover the bowl hole with the bowl cover 28 or the bracket 30. The user then pulls back the first handle 24 to expose the ground up material, the second handle 18 can automatically be pushed up by the tension of the spring. The user can then slide back the bowl cover 28 or the bracket 30 away from the bowl hole 17 revealing the bowl and the grinded material. The user can now light the grounded material and smoke it through the mouthpiece 56.

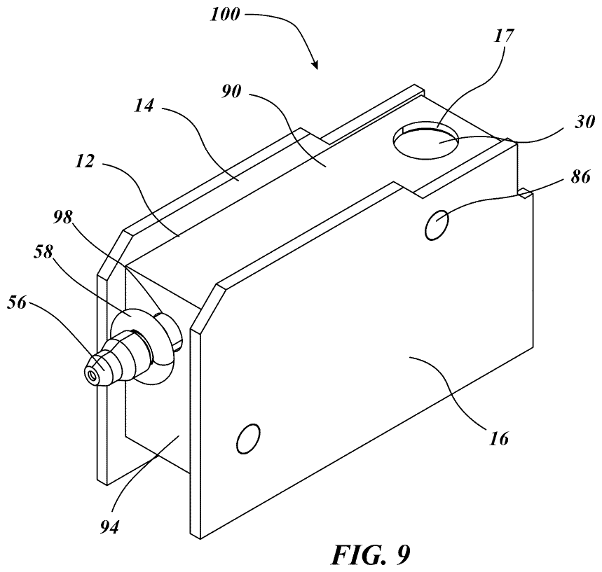

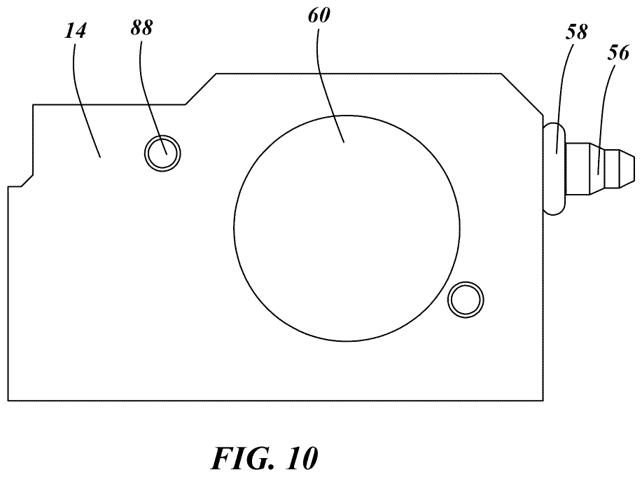

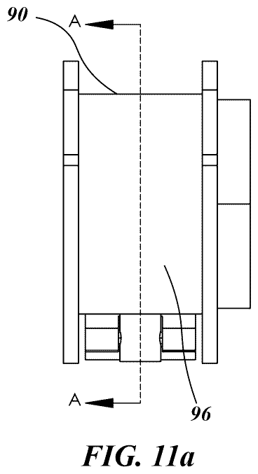

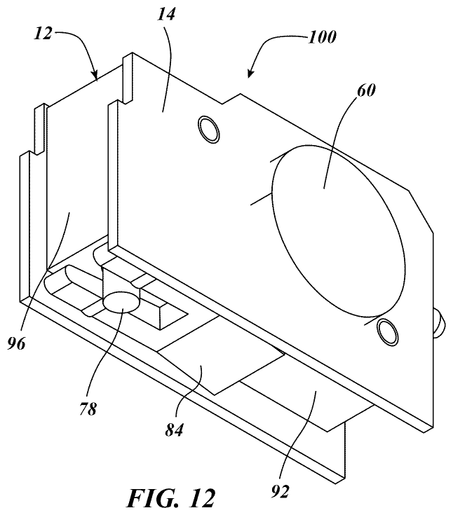

Referring FIGS. 9-12, another embodiment of a multipurpose utility smoking device for grinding, storing, loading, and then smoking is shown generally at 100. The multipurpose utility smoking device 100 can include a housing with a top 90, bottom 92, front 94, back 96, first panel 14, and second panel 16 defining a chamber 13. The top 90 of the housing features a bowl hole 17, the front 94 includes a mouthpiece opening 98, and the bottom 92 has a cam stem hole 88. The first panel 14 and the second panel 16 can be any suitable shape or size but in the preferred embodiment, the first panel and second panel can be the shape as shown in FIG. 9 or it can be such as, for example, square, rectangular, circular, polygonal or the like.

The second panel can have a grinder hole wherein a grinder 60 can be coupled to the second panel 16 of the housing 12 by such as, for example, press fit, adhesive, fastener, or the like. The grinder can be attached to the outer side of the second panel or can partially be in the second panel. Inside the chamber 13, a bowl 34 can be aligned with the bowl hole 17 and can be coupled to an adapter 76. A cam stem 78 is slidably coupled to the adapter 76 and further coupled to a lever 84 wherein the cam stem can be coupled by such as, for example threaded fittings, press fit, swage fittings, or the like. The cam stem 78 can have a first gasket 82 coupled to the bottom 92, and a first spring 80 coupled between the first gasket and the adapter wherein the first gasket can seal the cam stem hole 88 from any outside elements.

A mouthpiece 56 can be mounted to a mouthpiece stem 79, which is in fluid communication with the adapter via a tube 40. The tube 40 has a first end 72 and a second end 74. with the first end coupled to the mouthpiece stem 79 and the second end coupled to the adapter 76. The mouthpiece stem 79 can be housed within the chamber 13 and is slidably coupled to the mouthpiece opening 98. The mouthpiece stem 79 can also be coupled to a bracket 30 that can be configured to slide relative to the housing 12. The adapter 76 can be hollow allowing the second end 74 of the tube 40 to be coupled to it allowing for fluid communication between the bowl 34 and the mouthpiece 56. The tube 40 can be such as for example, plastic tubing, rubber tubing, metal tube, or the like and flexible allowing the mouthpiece to move in and out and allowing the bowl 34 to move up and down. The tube 40 can have a relief in it as shown in FIG. 11c which can help eliminate any tube kinking as the mouthpiece moves in and out from a smoking position to a nonsmoking position and the bowl 34 moves into the nonsmoking position.

The mouthpiece 56 can have a filter 66 coupled to its inner diameter and a mouthpiece stop 58 can be coupled to its outer diameter. The bracket 30 can have an open position and a closed position wherein when the bracket is in the open position, the bowl is exposed, and when in the bracket is in the closed position, the bowl is hidden under the bracket within the chamber. The lever 84 can pull the cam stem 78 vertically, moving the bowl 34 in a smoking position or a nonsmoking position. In the smoking position, the bowl 34 can be mated against the bowl hole 17, and in the nonsmoking position, the bowl can be mated against the bottom of the bracket 30. The bracket 30 can have a second spring 70 around the mouthpiece stem 79 coupled between the bracket 30 and a second gasket 68 axially aligned with the mouthpiece hole 98 and coupled to the housing 12 wherein the second gasket can seal the mouthpiece hole 98 from any outside elements.

In embodiments, the first spring 80 and the second spring 70 can be such as, for example, compression springs, linear spring, coil spring, helical spring, or the like. The bowl 34 can be made from various materials such as glass, metals, silicone, wood, or ceramic. The first panel 14 and second panel 16 can be coupled to the housing 12 by at least one fastener wherein the fastener can be such as, for example, bolts, screws, adhesive, rivets, or the like and can fasten the first panel 14 to the second panel 16 and onto the housing. In other embodiments, the first panel 14 and second panel 16 can be coupled to a pin 27 which can be such as, for example, cotter pin, hitch pin, spring pin, split ring pin or the like as shown in FIGS. 13-15b.

In embodiments, in operation, the user grinds their smoking material using the grinder, stores it in the bowl, and then loads it into the device. The user can then smoke the material by pulling on the lever to move the bowl into the smoking position, exposing the bowl through the bowl hole. After smoking, the user can move the bowl into the nonsmoking position, hiding it under the bracket within the chamber wherein when the cam stem is pulled the bracket 30 can snap closed. The mouthpiece can partially be slid in and out of the mouthpiece opening for easy cleaning and replacement. The device can be easily disassembled and reassembled for cleaning and maintenance by removing the fasteners coupling the first and second panels to the housing.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

What is claimed is:

1. A multipurpose utility smoking device for grinding, storing, loading, and then smoking comprising:
a housing having a top, a bottom, a front, a back, a first panel and a second panel defining a chamber wherein the top has a bowl hole, the front includes a mouthpiece opening and the bottom has a cam stem hole;
a grinder coupled to the second panel;
the chamber houses a bowl aligned with the bowl hole, coupled to an adapter,
a cam stem slidably coupled to the adapter and further coupled to a lever;
a mouthpiece mounted to a mouthpiece stem wherein the mouthpiece stem in fluid communication with the adapter and is housed within the chamber wherein the mouthpiece is slidably coupled to the mouthpiece opening and the mouthpiece stem is coupled to a bracket that is configured to slide relative to the housing.

2. The multipurpose utility smoking device according to claim 1, wherein the cam stem has a first gasket coupled to the bottom, and a first spring coupled between the first gasket and the adapter.

3. The multipurpose utility smoking device according to claim 1, wherein the mouthpiece stem is in fluid communication with the adapter by a tube having a first end and a second end wherein the first end is coupled to the mouthpiece stem and the second end is coupled to the adapter.

4. The multipurpose utility smoking device according to claim 1, wherein the mouthpiece has a filter coupled to its inner diameter and a mouthpiece stop coupled to its outer diameter.

5. The multipurpose utility smoking device according to claim 1, wherein the bracket has an open position and a closed position wherein the bracket is in the open position the bowl is exposed and when in the closed position the bowl is hidden under the bracket within the chamber.

6. The multipurpose utility smoking device according to claim 5, wherein the lever pulls the cam stem vertically moving the bowl in a smoking position or a nonsmoking position.

7. The multipurpose utility smoking device according to claim 6, wherein the smoking position the bowl is mated against the bowl hole and the nonsmoking position the bowl is mated against the bracket.

8. The multipurpose utility smoking device according to claim 2, wherein the bracket has a second spring around the mouthpiece stem coupled between bracket and a second gasket axially aligned with the mouthpiece hole and coupled to the housing.

9. The multipurpose utility smoking device according to claim 8, wherein the first spring and the second spring are compression springs.

10. The multipurpose utility smoking device according to claim 7, wherein the bowl is made from glass, metals, silicone, wood, or ceramic.

11. The multipurpose utility smoking device according to claim 1, wherein the first panel and second panel are coupled to the housing by at least one fastener.
